(19) United States
(12) Patent Application Publication
(10) Pub. No.: US 2009/0193457 A1
(43) Pub. Date: Jul. 30, 2009

(54) Systems and methods for providing run-time enhancement of internet video files

(76) Inventor: Eric Conn, Woodbine, MD (US)

Correspondence Address: CHRISTINE JOHNSON ESQ., 151 Trenton Rd., Fairless Hills, PA, 19030, US

(21) Appl. No.: 12/322,275

(22) Filed: Jan. 30, 2009

Related U.S. Application Data
(60) Provisional application No. 61/062,919, filed on Jan. 30, 2008.

(51) Int. Cl. H04N 7/025

(52) U.S. Cl. 725/34

(57) ABSTRACT

Methods and systems are provided for enhancing Internet video files at run-time with supplemental multimedia content constructed in real-time. The supplemental multimedia content may comprise any type of content that cannot be known and practically constructed prior to run-time of an Internet video file. The supplemental multimedia content may include locally and globally derived information, for example, advertising, alerts (e.g. weather, disaster), messaging, user-generated content, and proprietary content. According to one aspect, a browser cookie is stored onto the user's remote computing device. The browser cookie is capable of collecting various types of information about the user's behavior while visiting a web-site including Internet source video. This information collected within browser cookie may be periodically uploaded to a personal profile database for later use in assisting third party content providers with the targeting of future dynamic supplemental content based on the on-going collected demographic, behavioral, and geographical information of users.

### CROSS-REFERENCE TO RELATED APPLICATIONS

This application claims the benefit of prior filed co-pending U.S. application No. 61/062,919, filed on Jan. 30, 2008.

### BACKGROUND OF THE INVENTION

1. Field of the Invention

The present invention relates generally to the dissemination of information, and more particularly to systems and methods for enhancing Internet video files at run-time with supplemental multimedia content without disruption to the overall video viewing experience.

2. Description of the Related Art

Internet video is becoming an increasingly popular way for consumers to obtain information and interact on the Web. Broadband technologies such as digital cable, DSL, fiber optics, and satellite have increased bandwidth and accessibility to a large and growing number of users worldwide. Both user-generated content and professionally created videos are ubiquitous on websites and trends point to more source video in the future. The applications of Internet video are large and varied and include entertainment, news, weather, sports, social networking, and interactive commercials and advertisements.

Like the Web in general, consumers have grown accustomed to free access to source video and businesses have turned to advertising to offset the costs associated with producing and broadcasting video. Because of its technical implementation and ubiquity in the marketplace, Adobe Flash has emerged as the preferred platform for the distribution of web video and other continuous motion assets. Popular websites such as YouTube.com or slideshow creation applications like Slide.com use Flash as the base technology and have millions of movies available for immediate download to a user's browser. In addition, a Flash implementation enables users to easily embed their favorite source video as widgets on their preferred websites or social networks like Facebook.com or MySpace.com. This componentization and syndication of content has led industry observers to coin the term “Web 2.0” to describe the new paradigm.

Internet video publishers and distributors have used various techniques to generate revenue including placing pre-roll or post-roll video clip advertisements before or after the source video respectively or positioning other interactive or banner advertisements around the web page on which the source video resides. However, each of these methods suffer from shortcomings that have led to both consumer and advertiser dissatisfaction. For instance, TiVo-like video skipping technologies significantly reduce the effectiveness of any advertising added before or after source video. Also, the deconstruction of the web into individualized components via widgets has led to an erosion of web-page based advertising revenue for popular destination sites since personalized web pages sans advertisements can be easily created using widgets taken from other websites. In-video advertising has recently emerged as a potential compromise and studies have shown that consumers are more tolerant of this presentation format since it minimizes disruption of the viewing experience. However, all video advertising methods and presentations in the current art use generic augmentations developed ahead of time that are incapable of supporting arbitrary and individualized messages constructed at run-time. For example, it is common practice to insert generic branding messages from consumer product companies into Internet video however augmenting those generic ads on-the-fly with uniquely targeted messages responsive to unpredictable events is not currently possible. As a specific example, the Ford Motor Company may sponsor a nationwide or regional campaign around the theme of “Built Ford Tough” and purchase Internet video advertising. One or several versions of the ‘Built Ford Tough” creative material will be developed by an agency through a process that takes weeks or months and the approved material will be distributed on the Internet in numerous ways. In some cases, the “Built Ford Tough” video insert will be added to brand-friendly video material (pre-roll, in-video overlays, post-roll, etc.) in a dynamic fashion based on a user's behavior or geographical location as captured through browser cookies or IP addresses. However, in all cases, the video insert itself will be one of the pre-constructed versions and although it may be dynamically added or appended to the consumer's desired content, the actual content and message in the ad are static in nature.

To optimize campaign effectiveness and consumer relevance, it would be ideal to augment the static creative material with unique personalized information such that when a user John, who lives in Dayton Ohio, is served the Ford ad, it says something like “Built Ford Tough—Call Sally (301-555-1234) at Dayton Ford before 5 PM today and get Free Snow Tires.” This type of real-time information is not only individually targeted but cannot be created ahead of time since it is impossible to know that user John from Dayton Ohio will even see the advertisement or that a local dealer, such as Dayton Ford in this example, will sponsor free snow tires based on a local weather event or excess inventory. Finally, the uniquely targeted real-time messages or images must be presented in a manner consistent with the overall creative element and look-and-feel of the approved static material to achieve the level of professionalism desired by the sponsor and expected by the customer.

### SUMMARY OF THE INVENTION

Therefore, the present invention has been made in view of the above problems. Accordingly, there are provided herein methods and systems for enhancing Internet video files at run-time with supplemental multimedia content constructed in real-time. The supplemental multimedia content may comprise any type of content that cannot be known and practically constructed prior to run-time of an Internet video file. The supplemental multimedia content may include, for example, advertising, alerts (e.g. weather, disaster), messaging, user-generated content, and proprietary content. In contrast to prior art approaches for dynamically inserting content into a video stream, it is appreciated that all of the aforementioned exemplary supplemental content types share the similar feature of not being amenable to being pre-stored in a database but by necessity must be constructed, retrieved, and disseminated “on-the-fly” (i.e., in real-time).

In accordance with embodiments of the invention, Internet video files are dynamically enhanced at run-time via the insertion of supplemental multimedia content constructed in real-time, provided by third party content providers. Further, the enhancement process is transparent to the user. That is, enhancement of the Internet video file is performed without the need to reload the video file. In other words, insertion of the supplemental content is performed in a timely and transparent manner to the viewer so as to not disrupt the overall video viewing experience and enhance the relevance of the Internet video file.

In one aspect of the invention, a method is provided for enhancing Internet video files at run-time with supplemental multimedia content, the method including the steps of: receiving a request to view a video being displayed at a web page, retrieving the source video from a third party source video provider, playing the requested video selection to a requesting user at the web page, substantially concurrent with said playing step performing the steps of: (1) providing an indication of the requested video selection being played to the requesting user to at least one third party supplemental content provider, (2) said at least one third party supplemental content provider dynamically constructing supplemental content in real-time having some relevance to one of the requesting user and/or the requested video (3) dynamically inserting the constructed supplemental content into the Internet video selection being played to the requesting user in real-time. The method further comprises a preparatory step of enabling the source video to allow the dynamic insertion of the constructed supplemental content. In different embodiments, enablement may be performed during the creation stage of the source video, during development or update of the video player used to view the video, or at a video transcoding stage through the use of a specifically designed software component.

In a related aspect of the invention, a browser cookie may be stored on a user's computer to collect information related to the user's behavior while interacting with a web site configured for viewing video files. In this manner, the personal information collected by the browser cookie may be periodically uploaded to third party supplemental content providers, such as advertising networks to enhance the relevance of the supplemental content to be inserted into the source video at a later date or time in the form of personalized supplemental content. It should be understood, however, that the personalization of the content does not imply or presume that the content is created a-priori. Rather, supplemental content is dynamically created and integrated in real-time, and is preferably customized or personalized to the pre-established preferences of each viewer, as it is being dynamically created in real-time The information collected by the browser cookie may include, without limitation, demographic information, behavioral and geographic information, a user's IP address and/or URL of the web page at which the viewing experience is being conducted.

In a further related aspect of the invention, a system is provided for dynamically enhancing Internet video files at run-time with supplemental multimedia content constructed in real-time, the system comprising: an enabling component, a supplemental content server, a supplemental content interface, a tracking and analysis module, and an administrative and control portal.

A primary, but not exclusive, advantage provided by the invention is the capability for advertisers, publishers and other supplemental content providers to dynamically enhance Internet video files in real-time to provide viewers of source video with personalized supplemental content, constructed in real-time to supplement primary source video selected to be viewed by a viewer at a web site. By enhancing the source video to be viewed with the personalized supplemental content, the supplemented content desirably has maximum relevance to the viewer without having to reload or disrupt the viewer's viewing experience. As disclosed herein, this is achieved in a number of ways, including, for example, providing the advertisers, publishers and other content providers with capabilities to insert unique messages at the run-time of the Internet source video; and the ability to modify the nature or message of distributed source video or advertisements in response to unpredictable global and local events such as breaking news, weather, traffic, inventory levels, campaign success, and other unpredictable factors which are now apparent to the reader.

Other related advantages provided by the invention include support for local, regional, and global targeting; reduced footprint within a web page; automatic proliferation of new content or advertisement via current widget embedding techniques since new material is part of the video and contained within the same video file; support for interactive in-video applications such as multi-user embedded chat or real-time commentary; increased consumer-to-advertisement engagement since advertisement is in-line with user's desired content; open architecture approach compatible with most content delivery systems; minimal disruption to user experience since there is no Internet browser refresh, additional video downloads, or video reloading necessary, and guaranteeing viewing of customized content and advertisements by not allowing potential consumers to skip over overlaid advertisements without missing segments of their desired content.

### BRIEF DESCRIPTION OF THE DRAWINGS

These and other aspects, features and advantages of the present disclosure will be described or become apparent from the following detailed description of the preferred embodiments, which is to be read in connection with the accompanying drawings.

FIG. 1 is an exemplary system for enhancing Internet video files in real-time with supplemental multimedia content, according to one embodiment.

FIG. 2 is a flow diagram illustrating a process for providing run-time Internet video file enhancement, according to an illustrative embodiment of the function of Internet video file enhancement system 100 of FIG. 1.

FIGS. 3a & 3b illustrate portions of an Internet video file during playback, where FIG. 3a is a frame of the Internet video file without supplemental content and FIG. 3b is a subsequent frame of the Internet video file including supplemental content constructed in real-time targeted to a specific user based on locale and preferred movie theater.

### DETAIL DESCRIPTION OF THE PREFERRED EMBODIMENTS

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudo-code, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate hardware. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

To simplify the examples given herein, this description concentrates on the Adobe Flash video file format as the chosen or pre-determined video file format. The scope of the invention, however, is not so limited and contemplates the use of any streaming or compiled video file format. Examples of other existing video file formats include Windows Media Video (WMV), Motion Picture Experts Group (MPEG), Audio-Video Interleaved (AVI), Microsoft Silverlight, and QuickTime.

Further, while described below with respect to Internet video files, the present invention provides a generic capability for enhancing a sequence of still images in real-time. A more detailed discussion of enhancing still images is discussed in co-pending application Ser. No. 11/515,531 dated Sep. 5, 2006 incorporated by reference herein in its entirety.

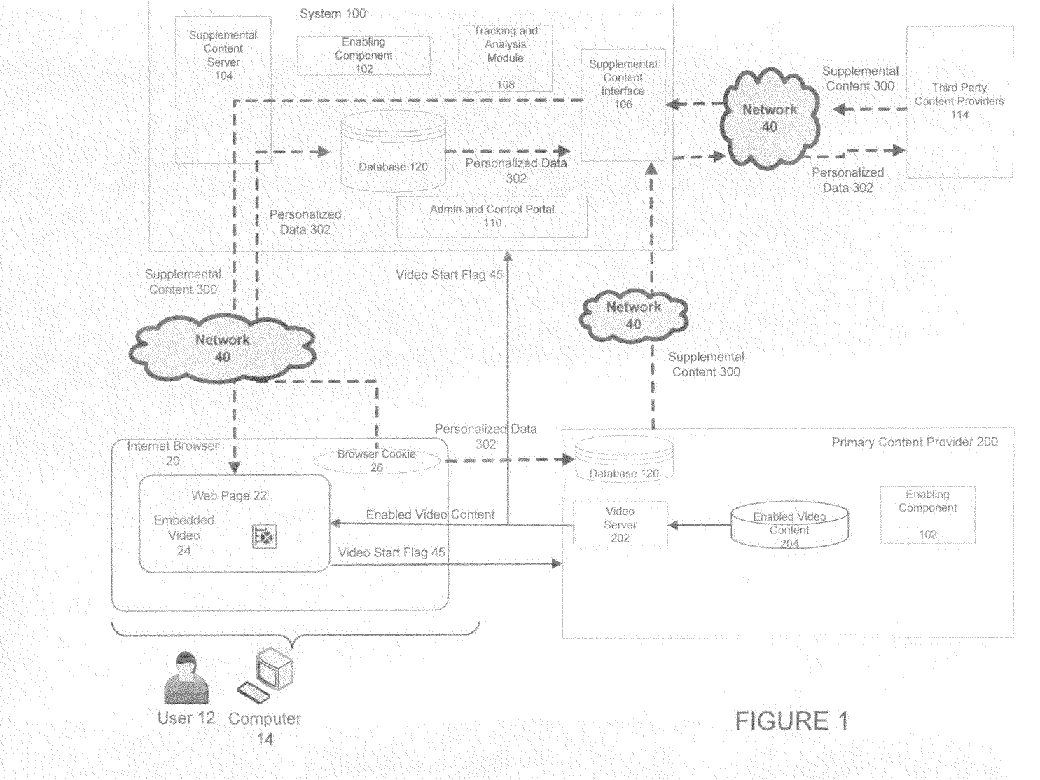

With reference now to FIG. 1 there is shown and described functional elements of system 100, which operate in an environment conducive to carrying out the method of the invention according to one embodiment. It should be understood that this depiction and the description accompanying it provide one illustrative example from among a broad variety of different embodiments intended for system 100. Accordingly, none of the particular details in the following description are intended to imply any limitations on other embodiments.

System 100 provides capabilities for customizing source videos, which can be, for example, Internet video files that are supplemented at run-time with supplemental multimedia content to provide maximum relevance to individual end users.

Throughout this description, the term “source video”, “Internet video file(s)”, and “digital video” all connote a digital encoding of a series of images with the intent to view the images in sequence. There is no implied limitation on a digital video's duration, or the final medium which a digital video may be expressed. Examples of a digital video include, but are not limited to, the following: a portion of a current or classic movie or television show, an entire film or TV show, an advertisement, or a music video. The above terms all refer to video files that are digitally transmitted over a communication medium, such as the Internet. The Internet video files or source video is viewable on computers, mobile devices or other special-purpose devices.

Throughout this description, the term “supplemental multimedia content”, “personalized multimedia content”, or “dynamic supplemental media content” all connote content comprising two components. A first component comprising images to be inserted into the “source video” as defined above and a second component comprising meta-data describing how the images are to be presented to a viewer.

System 100 is seen to include enabling component 102, supplemental content server 104, supplemental content interface 106, tracking and analysis module 108, and admin and control portal 110.

Enablement as a Prerequisite to Enhancing an Internet Video File

To permit a source video to be enhanced with dynamic supplemental multimedia content, the source video or video player must first be appropriately configured to accept the dynamic supplemental multimedia content. Enabling component 102 provides the means by which to configure the source video. Specifically, enabling component 102 configures the source video via the insertion of generic methods and functions that control the presentation and timing and duration of the dynamic supplemental multimedia content to be inserted into the source video in real-time at a future point in time (e.g., when selected by a user at a web site). Stated alternatively, enabling component 102 is configured to enhance any Internet video file or video player by permitting or configuring the real-time insertion of supplemental multimedia content into an Internet video selected by a user 12 (e.g., embedded video 24).

In some embodiments, enabling component 102 is preferably configured as a software component or plug-in provided to content providers of the source video to be displayed to a user, such as primary content provider 200. This software component or plug-in is provided at a set up or preparatory stage prior to the source video being made available for playback. It should be appreciated that the enablement process is a necessary pre-requisite for configuring standard Internet video files to permit the real-time insertion of dynamic supplemental content.

In one embodiment, the enablement process may be performed at a preliminary or set up stage on an Internet video file or video player as it is being constructed. In such an embodiment, process for enabling a newly constructed Internet video file is to create the new Internet video file using standard tools and techniques and configure the newly created Internet video file via the introduction of certain enablement features via enabling component 102.

In another embodiment, the enablement process may be performed at a preliminary or set-up stage on a pre-existing Internet video file or video player. In such an embodiment, the pre-existing Internet video file is re-compiled or transcoded using enabling component 102.

In those embodiments where the standard Internet video file is in the Flash™ flv file format, enablement is performed by enabling component 102 using Adobe Flash™. In accordance with such an embodiment, the enabling component 102 is comprised of an ActionScript class that can be included in a Flash™ flv video production or video player manually by the video producer or automatically through a batch process.

Composition of Supplemental Content

It should be understood that dynamically generated supplemental personalized content is comprised of two general components, a first component comprising images to be inserted and a second component comprising meta-data describing how the images are to be presented to a viewer. With regard to the first component, images may include any combination of common static or dynamic visual elements such as text, icons, images, hyperlinks, video and the like. Other well-known visual elements commonly used by those knowledgeable in the art of presentation graphics are well within contemplation of the invention. It is therefore understood that there are no limitations or restrictions imposed on the type or form of dynamically generated supplemental content that may be used.

With regard to the second component, meta-data describes how the images are to be displayed. In some embodiments, the meta-data may include, for example, well-known transition effects such as slide-ins, rotations, fade-ins/fade-outs, and highlights may be applied to provide visual interest to the viewer. Of course, future envisioned meta-data for determining how images are to be displayed (e.g., effects, colorization, fonts, etc.) are also within contemplation of the invention.

It should be appreciated that insertion of the dynamic supplemental content into an Internet video file or stream being played by a user can be invoked at any point during the course of playback of the Internet video. For example, insertion may be invoked when the Internet video is first loaded, at any point during playback or upon conclusion of playback, or combinations of the above. The insertion point in time may be based on different indicia, including, for example, user triggers such as a mouse click or mouse over or external events initiated by third-parties such as primary content provider 200 or third party content providers 114. The methods and functions may also be invoked repeatedly with different options and/or different supplemental content during the course of video playback.

User's Computing Device

With continued reference to FIG. 1, the user's computing device 14 can be any fixed or mobile device, including mobile phones or PDAs, capable of supporting Internet video. The computing device 14 may support any suitable installation device, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs such as any software 120, or portion thereof, related to the intelligent delivery system described herein. The computing device 14 may further comprise a storage device, such as one or more hard disk drives or redundant arrays of independent disks, for storing an operating system and other related software, and for storing application software programs such as any program related to system 100. Furthermore, the computing device 14 may include a network interface to interface to a Local Area Network (LAN), Wide Area Network (WAN) or the Internet through a variety of connections including, but not limited to, standard telephone lines, LAN or WAN links (e.g., 802.11, T1, T3, 56 kb, X.25), broadband connections (e.g., ISDN, Frame Relay, ATM), wireless connections, or some combination of any or all of the above. The network interface may comprise a built-in network adapter, network interface card, PCMCIA network card, card bus network adapter, wireless network adapter, USB network adapter, modem or any other device suitable for interfacing the computing device 14 to any type of network capable of communication and performing the operations described herein. A wide variety of I/O devices may be present in the computing device 14. Input devices include keyboards, mice, trackpads, trackballs, microphones, and drawing tablets. Output devices include video displays, speakers, inkjet printers, laser printers, and dye-sublimation printers. The I/O devices may be controlled by an I/O controller. The I/O controller may control one or more I/O devices such as a keyboard and a pointing device, e.g., a mouse or optical pen. Furthermore, an I/O device may also provide storage and/or an installation medium for the computing device 14.

A computing device 14 of the sort depicted in FIG. 1 typically operates under the control of an operating system, which control scheduling of tasks and access to system resources. The computing device 14 can be running any operating system such as any of the versions of the Microsoft® Windows operating systems, the different releases of the Unix and Linux operating systems, any version of the Mac OS® for Macintosh computers, any embedded operating system, any network operating system, any real-time operating system, any open source operating system, any proprietary operating system, any operating systems for mobile computing devices or network devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, and WINDOWS XP, all of which are manufactured by Microsoft Corporation of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

In other embodiments, the computing device 14 may have different processors, operating systems, and input devices consistent with the device. The computing device 14 can be any workstation, desktop computer, laptop or notebook computer, server, handheld computer, mobile telephone or other portable telecommunication device, media playing device, a gaming system, or any other type and/or form of computing, telecommunications or media device that is capable of communication and that has sufficient processor power and memory capacity to perform the operations described herein. For example, the computing device 14 may comprise a device of the iPod family of devices manufactured by Apple Computer of Cupertino, Calif., a Playstation 2, Playstation 3, or Personal Playstation® Portable (PSP) device manufactured by the Sony Corporation of Tokyo, Japan, a Nintendo DS™ or Nintendo Revolution™ device manufactured by Nintendo Co., Ltd., of Kyoto, Japan, or a XbOX™ or Xbox 360™ device manufactured by the Microsoft Corporation of Redmond, Wash.

Supplemental Content Server 104

For the exemplary system embodiment shown in FIG. 1, the supplemental content server 104 suitably communicates with the embedded source video 24 of web page 22 to dynamically insert supplemental multimedia content in real-time in accordance with invention principles. The dynamic supplemental multimedia content can be provided by a variety of sources including the primary provider of embedded video 24, i.e., primary content provider 200 or from any number of third party content providers 114 as shown.

Browser Cookie 26

A browser cookie 26 may be stored onto the user's remote computing device 14 by Internet browser 20 when the user 12 first visits web page 22. Thereafter, the browser cookie 26 can be updated with new data each time the user 12 returns to web page 22. The browser cookie 26 is capable of collecting various types of personal information about the user's behavior while visiting web page 22. This personalized information collected within browser cookie 26 may be periodically uploaded to a personal profile database 120 associated with system 100 during each activity session of user 12 for later use in assisting third party content providers 114 with the targeting of future dynamic supplemental content based on the on-going collected demographic, behavioral, and geographical information of users, such as user 12.

The browser cookie 26 is configured to store the user's local settings and other profile information. The supplemental content server 104 is also configured to inject supplemental content into the video stream of embedded video 24 at run-time as it is being played to the user 12.

It should be understood that all of the data collected about a user 12 is collected by and made available from system 100 for transmission to third-party content providers 114 such as, for example, advertising networks or affiliate partners via the personalized data 302 connections from system 100. These third-parties may use the collected data to enhance the relevance of future supplemental content 300 for insertion into embedded video 24.

System 100 is also configured to exploit information contained in browser cookie 26 or other information such as IP address and URL to automatically insert or modify content and advertisements uniquely targeted for users such as User 12 based on settings approved by primary content provider 200.

Supplemental Content Interface 106

Supplemental content interface 106 provides a two-way interface to external systems and third-party content providers 114. It is configured to receive supplemental content 300 as defined herein directly from one or more third-party supplemental content providers 114 who have been pre-approved by primary content provider 200. The Supplemental Content Interface 106 is also configured to forward personalized data 302 derived from browser cookie 26, to the one or more external third party content providers 114 such as, for example, advertising networks for the purpose of gathering statistics to provide increasingly targeted dynamic personalized supplemental content and advertisements to viewers in the future in the form of dynamically (i.e., real-time) generated personalized supplemental content.

Tracking and Analysis Module 108

For the embodiment shown in FIG. 1, tracking and analysis module 108 of system 100 is configured to monitor and record real-time events associated with “enabled” source video. The real-time events, may include, for example, the time that the Internet video file is loaded onto the web page 22, the identity of the web page 22 the Internet video file was loaded onto, which web site the user is redirected to when the user 12 clicks on or mouses over the embedded video 24, the type of dynamic personalized supplemental content 300 served in real-time from the third-party content providers, and other pertinent information related to various aspects of the form, use and function of the embedded video 24 being viewed by the user 12, which should now be apparent to the reader. In certain embodiments, the tracking and analysis module 108 may store demographic, behavioral, and geographic information made available to the tracking and analysis module 108 from database 120 via browser cookie 26. All of the information collected the tracking and analysis module 108 may be provided to the admin and control portal 110 so that overall system performance can be monitored, controlled, and analyzed. It is understood that the tracking and analysis module 108 operates on the raw data collected in database 120 to organize it into a form suitable for analysis by the third party content providers 114 and/or primary content provider 200.

Admin and Control Portal 110

Admin and control portal 110 is preferably a password-protected area of system 100 that permits primary content provider 200, third party content providers 114 and other approved parties to monitor and interact with dynamically generated personalized supplemental content. For instance, third party content providers 114 may actively create or modify the dynamically generated personalized supplemental content on-the-fly and push it to individual viewers or groups of viewers in certain situations. Categories of dynamically created personalized supplemental content include breaking events, bulletins, special sales, and other time-critical or geographically-focused information. It is understood that such content is personalized in the sense that it has some relevance to the viewer and/or to a video that the viewer has selected.

In addition to receiving information from the tracking and analysis module 108, as described above, the admin and control portal 110 is further configured to receive supplemental content 300 from primary content provider 200, via the admin and control portal 110. Alternatively, system 100 can receive dynamically generated personalized supplemental content 300 directly from a third-parties approved by primary content provider 200 via supplemental content interface 106.

Content providers, such as primary content provider 200, are also able to query personalized data 302 from system 100 to assist with targeting the dynamically generated personalized supplemental content 300. It is understood that, irrespective of whether primary content provider 200 provides the dynamically generated personalized supplemental content directly or indirectly via a third-party provider, primary content provider 200 can retain, at its option, control over the type, presentation, and timing of new supplemental content to be eventually incorporated into embedded video 24. Admin and control portal 110 allows third party content providers 114, advertising networks, and other third-parties to interactively analyze viewer reaction and perform market testing for individual, local or regional campaigns since changes can be made and performance visualized and measured in real-time.

In FIG. 1, the primary content provider 200 is shown as existing separate from system 100. However, system 100 may also reside within the primary content provider 200 or within other third-party systems provided it has sufficient connectivity to the Internet.

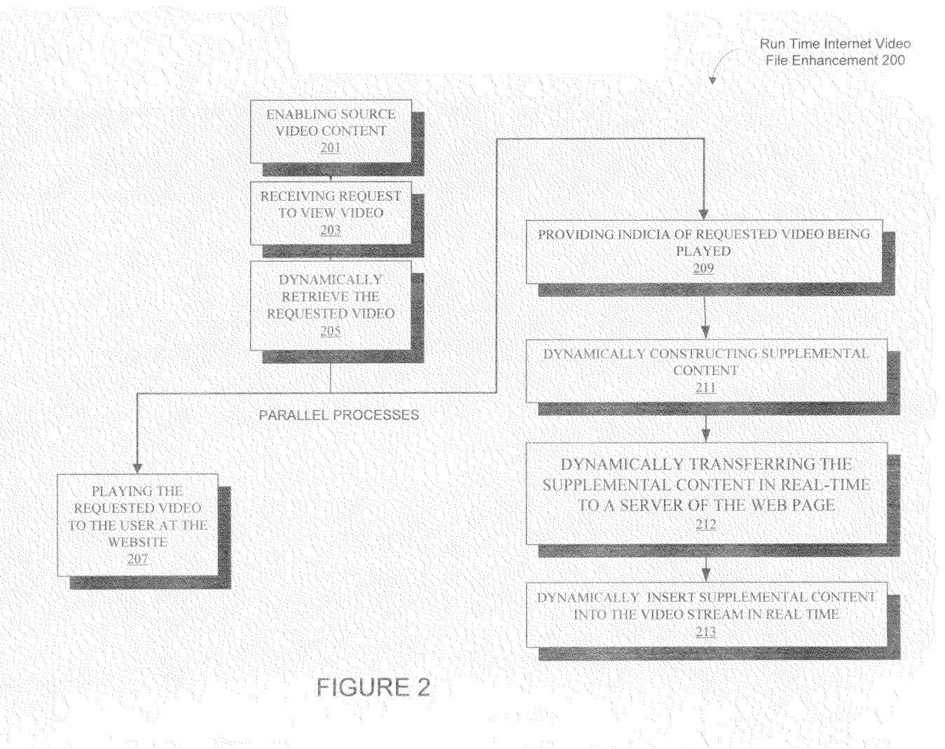

FIG. 2 depicts a flowchart of a method 200 for providing run-time (i.e., real-time) Internet video file enhancement, according to an illustrative embodiment of the function of Internet video file enhancement system 100 of FIG. 1. Method 200 includes:

At Step 201, at a preparatory stage, enabling the source video to allow the dynamic insertion of the constructed supplemental content. In different embodiments, enablement may be performed during the creation stage of the source video, during creation or update of the video player or widget used to play source video, or at a transcoding stage through the use of a specifically designed software component.

At Step 203, receiving a request from a viewer to view a video whose title or other identifying indicia is being displayed at a web page.

At Step 205, responsive to receiving the user request to view the video, retrieving the source video, either locally, for example, from a video database coupled to the web page, or remotely from a third party source video provider.

At Step 207, playing the requested video selection to a requesting user at the web page,

Substantially concurrent with said playing step 207 performing the steps of:

At Step 209, providing an indication of the requested video selection being played to the requesting user to at least one third party supplemental content provider. Referring again to FIG. 1, the indication of the requested video selection is provided via video start flag 45 which is automatically detected from web page 22 in response to the user initiating the playback of embedded video 24. In some embodiments, the supplemental source video may be generated in part from the at least one third party supplemental content provider and in part from local data associated with the web page.

At Step 211, the at least one third party supplemental content provider dynamically constructs supplemental content in real-time, where the supplemental content is constructed to have some indicia of relevance to either the video requestor and/or the requested video being played. In other words, the supplemental content is personalized to the viewer as it is being generated dynamically in real-time.

Step 212, said at least one third party supplemental content provider dynamically transferring the personalized supplemental content in real-time to a server associated with the web page.

Step 213, dynamically inserting the dynamically generated personalized supplemental content into the Internet video selection, selected by, and being played to the requesting user in real-time without disruption to the user's viewing experience. In other words, insertion of the supplemental content is transparent to the user. For example, the source video is not stopped, rewound, paused, for the purpose of supplementing the Internet video selection with the supplemental content.

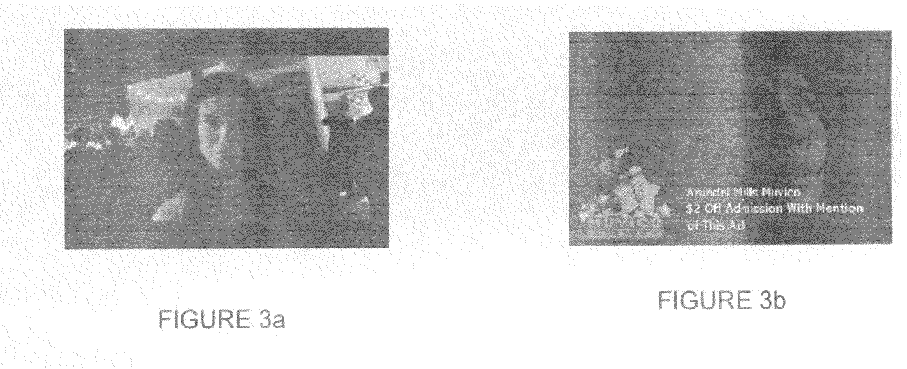

Referring now to FIGS. 3a and 3b, there is shown two exemplary screen shots of an Internet video file, such as embedded video 24 shown in FIG. 1, being played back to a user 12 at web page 22. FIG. 3a illustrates a screen shot at a point in time prior to the dynamic insertion of supplemental content. In the instant example, the exemplary embedded video 24 shown in FIGS. 3a and 3b is directed to a movie trailer. As is well-known, web sites typically incorporate movie trailer videos as content made available to viewers to promote current movie offerings and films.

In accordance with invention principles, to enhance the viewer experience and relevance of being shown such movie trailers. The viewer is shown supplemental content as an enhancement to the movie trailer. In operation, at some point during the viewing experience, a viewer is shown the supplemental content. This is shown as a single frame of information in FIG. 3b. The supplemental content in the instant example provides the viewer 12 with an opportunity to receive a discounted ticket at a local theater. It should be appreciated that the discounted ticketing availability information is both current and highly viewer specific. In other words, the discounting has applicability for a brief period of time and is relevant only in the viewer's viewing geography.

Timeliness and relevance occur as a consequence of the supplemental content being dynamically constructed and retrieved in real-time from supplemental content providers upon being notified of viewer 12 initiating playback of the movie trailer, i.e., embedded video 24, at web site 22.

When the viewer 12 clicks on embedded video 24. At that point in time, a signal, (e.g., video start flag 45 as shown in FIG. 1) is transmitted in real-time to one or more supplemental content providers, including the primary content provider 200, supplying the movie trailer, and in addition, one or more third party content providers 114, all of which are configured to provide supplemental content at their option. Video start flag 45 includes certain indicia to allow the supplemental content providers 114, 200 to identify user 12 as the particular viewer of the movie trailer. In the event a supplemental content provider 114, 200 decides to dynamically insert supplemental content into the movie trailer video, the supplemental content provider 114, 200 can perform a database lookup of the particular viewer 12 to retrieve the viewer's personal profile information. In this manner, the supplemental content provider can customize the supplemental content to the particular viewer 12 to thereby create personalized supplemental content. As discussed above, the personal profile information can include different kinds of information including, for example, zip code information or instantaneous geo-location data which allows the supplemental content provider 114, 200, in the instant example to identify local movie theaters which may be offering discounts of potential interest to viewer 12. Recall from the discussion above that personal information is collected by a browse cookie provided to user 12 upon the first visit to the web site. The information collected by the browser cookie is periodically uploaded to third parties supplemental content providers 114, 200, such as advertising networks to enhance the relevance of the supplemental content to be inserted into the source video at a later date or time. It should also be appreciated that the supplemental content is provided to the viewer without having to re-start the playback of the movie trailer or hinder or restrict the viewing experience in any manner.

Multiple variations and modification to the disclosed embodiments will occur, to the extent not mutually exclusive, to those skilled in the art upon consideration of the foregoing description. For example, not all steps are required to be performed in the order disclosed and in fact some steps may be skipped altogether in certain embodiments of the invention. Such variations and modifications, however, fall well within the scope of the present disclosure as set forth in the following claims.

What is claimed is:

1. A method for dynamically enhancing a source video with personalized supplemental multimedia content in real-time to personalize the source video thereby providing maximum relevance to viewers of the digitally transmitted video without reloading or disrupting a viewer's viewing experience, the method comprising:
a) receiving a request at a web page from the viewer to view the source video;
b) playing the requested source video to said requesting viewer at the web page;
c) substantially concurrent with said step (b) performing the steps of:
i) providing, to at least one external third party supplemental content provider, an indication that the requested source video has been selected by the viewer at the web page;
ii) dynamically constructing, in real-time, by said at least one external third party supplemental content provider, personalized supplemental content to be inserted into the requested source video at said web page in real-time;
iii) transferring said dynamically constructed personalized supplemental content in real-time, from said at least one external third party supplemental content provider to a URL associated with said web page; and
iv) dynamically inserting the dynamically constructed personalized supplemental content into the requested source video at said web page in real-time as it is being played to the requesting viewer.

2. A method according to claim 1, further comprising enabling a source video player unit to accommodate the dynamic insertion of the dynamically constructed supplemental content into the requested source video prior to said step (a).

3. A method according to claim 1, further comprising a step of enabling the requested source video to accommodate the dynamic insertion of the dynamically constructed supplemental content into the requested source video prior to said step (a).

4. A method according to claim 2, wherein enabling the requested digitally transmitted video file is performed during a video creation stage prior to said step (a).

5. A method according to claim 2, wherein enabling the requested internet video file is performed during a video transcoding stage prior to said step (a).

6. A method according to claim 1, wherein the dynamically constructed supplemental content is personalized to provide some measure of personal relevance to the viewer of the requested digitally transmitted video.

7. A method according to claim 1, wherein the dynamically constructed supplemental content is personalized to provide some measure of relevance to the requested source video selected by the viewer.

8. A method according to claim 1, wherein the real-time insertion of the dynamically constructed supplemental content into the requested source video being played to the requesting viewer in real-time is transparent to said requesting viewer so as to not disrupt the viewer's viewing experience.

9. A method according to claim 1, further comprising the step of storing a browser cookie on a computer of said viewer to collect information related to said viewer's behavior while said viewer is interacting with said web site, said collected information being indicative of personal preferences of said viewer and/or personal preferences of digitally transmitted video selected by said viewer.

10. A method according to claim 9, further comprising the step of periodically uploading the collected information stored in said browser cookie to one or more external third party supplemental content providers to provide said one or more external third party supplemental content providers with information indicative of personal preferences of said viewer or of digitally transmitted video selected by said viewer.

11. A method according to claim 1, wherein the step of dynamically inserting supplemental content by one or more external third party supplemental content providers in real-time comprises at least one of: a) inserting one or more unique messages into the requested source video, b) modifying a pre-existing message already contained within the requested source video.

12. A method according to claim 11, wherein the one or more unique messages comprise an unpredictable event occurring in real-time substantially coincident with said viewer requesting or viewing said source video.

13. A method according to claim 1, wherein said dynamic supplemental content is comprised of a first component comprising images and a second component comprising meta-data describing how the images are presented to said requesting viewer.

14. A method according to claim 13, wherein said images comprise combinations of common static and dynamic visual elements.

15. A method according to claim 14, wherein said common static and dynamic visual elements comprise: text, icons, images, hyperlinks and video.

16. A method according to claim 13, wherein said meta-data comprises transition effects and presentation information such as size, placement, color, and fonts.

17. A system for dynamically enhancing digitally transmitted video with personalized supplemental multimedia content in real-time to personalize the digitally transmitted video to provide maximum relevance to viewers of the digitally transmitted video without reloading or disrupting the viewer's viewing experience, the system comprising:
an enabling component for configuring a digitally transmitted video file to enable the real-time insertion of dynamic supplemental multimedia content at run-time;
a supplemental content server configured to communicate with pre-enabled embedded digitally transmitted video of a web page to dynamically insert said dynamic supplemental multimedia content into the source video as it is being played to a viewer in real-time; and
a supplemental content interface configured to provide a two-way interface to external systems and external third-party content providers of said dynamic supplemental multimedia content and further configured to periodically forward personalized data derived from a browser cookie to said one or more external third party content providers.

18. A system according to claim 17, further comprising:
a tracking and analysis module configured to monitor and record real-time events associated with enabled source video and organize the recorded real-time events into a form suitable for analysis by external third-party content providers and/or primary content providers;
a personal profile database for storing historical and current personalized data used to determine maximum relevancy of dynamic supplemental content; and
an administrative and control portal for monitoring and controlling the insertion of dynamic supplemental content

19. A system according to claim 18, wherein said real-time events comprise (a) the time the source video is loaded onto the web page, (b) the identity of the web page the source video was loaded onto, (c) which web site the viewer is redirected to when the viewer selects embedded source video, (d) the type of supplemental content served in real-time from the external third-party content providers, and other information related to various aspects of the form, use and function of the source video.

20. A system according to claim 17, wherein said enabling component comprises one of a software component or plug-in module provided to primary content providers of the digitally transmitted video.

21. A system according to claim 17, further comprising a browser cookie, stored on a viewer's remote computing device configured to collect information related to the viewer's behavior while visiting said web page.

22. A system according to claim 21, wherein said browser cookie is periodically uploaded to a personal profile database during each activity session of said viewer for later use in assisting external third party content providers with targeting of future dynamic supplemental content based on on-going collected demographic, behavioral, and geographical information of viewers, wherein said personal profile database stores historical and current personalized data used to determine maximum relevancy of said future dynamic supplemental content.

23. A system according to claim 17, wherein configuration of said digitally transmitted video by said enabling component comprises the insertion of generic methods and functions that control the presentation, timing and duration of said dynamic supplemental media content.
